(19) United States
(12) Patent Application Publication
(10) Pub. No.: US 2017/0213233 A1
(43) Pub. Date: Jul. 27, 2017

(54) METHOD AND SYSTEM FOR A VISIT-BASED LOYALTY REWARD PROGRAM

(71) Applicant: Wal-Mart Stores, Inc., Bentonville, AZ (US)

(72) Inventors: Donald R. High, Noel, MO (US); Michael D. Atchley, Springdale, AR (US)

(73) Assignee: Wal-Mart Stores, Inc., Bentonville, AR (US)

(21) Appl. No.: 15/329,379

(22) PCT Filed: Jul. 28, 2015
(86) PCT No.: PCT/US15/42360

§ 371 Date: Jan. 26, 2017

Related U.S. Application Data
(60) Provisional application No. 62/030,369, filed on Jul. 29, 2014.

(51) Int. Cl. G06Q 30/02; H04W 4/02; H04W 4/00; G06Q 20/38; H04L 29/08

(52) U.S. Cl. CPC G06Q 30/0226; G06Q 20/387; H04L 67/306; H04W 4/008; H04W 4/021; G06Q 20/20

(57) ABSTRACT

This disclosure relates to methods and systems for implementing a visit- based loyalty rewards program. Disclosed is a system that includes location detection devices placed throughout a retail store that are used in conjunction with a mobile device carried by a customer to determine the presence, duration, path, and location of the customer device, and hence the customer, in the retail store. A retail store server is used to store customer information, including the customer visits, the length of customer visits, and the path taken by the customer through the retail store. A loyalty reward is calculated based upon at least one customer visit and at least one customer purchase. The loyalty reward is then awarded to the customer.

### FIELD OF THE INVENTION

This application relates to rewards programs for customers of a retail store, and specifically to a reward program based on customer visits to the retail store.

### BACKGROUND

Loyalty programs for retail stores have been used in which customer purchases are tracked based on the scanning of a loyalty card or the recording of a customer identifier at checkout. Customer rewards may be calculated based on the amount spent, and information regarding the products purchased may be used by the retailer to improve store sales.

However, simply recording the amount of money spent and/or items purchased by a particular customer associated with a loyalty card or identifier does not allow for robust data gathering and customization of the customer experience. Further, other behavioral indicators beyond the amount spent during a current trip may be indicative of future spending. Current systems and methods do not allow for detecting such behaviors, let alone allow for a rewards program configured to encourage them.

Additionally, existing card-based loyalty programs can become cumbersome as customers begin to require multiple cards, one for each commonly visited retailer. The need to carry and remember to scan cards can become an obstacle that limits participation in loyalty programs.

Accordingly, there is a need for methods and systems for operating a customer loyalty program that detects and rewards behaviors that may lead to increased sales, improved customer experience, or the collection of valuable customer data.

### BRIEF DESCRIPTION OF THE DRAWINGS

FIG. 1 is a block diagram showing a system for implementing a visit-based loyalty reward program;

FIG. 2 is a simplified drawing of a customer path through a retail store equipped with a plurality of location detection devices;

FIG. 3 illustrates a method of implementing a visit-based loyalty reward program.

### DETAILED DESCRIPTION

In addition to the amount of money a customer spends during a visit to a retail store, the frequency or number of visits over time and the duration of visits can be indicative of purchasing activity in the future. These metrics are not readily ascertainable from the data collected from loyalty reward card usage. To record these metrics and encourage customer behaviors through rewards, the systems and methods disclosed herein describe tracking customer behavior using location detection devices in the retail store, and/or an application residing on a customer device such as a smart phone.

In general, a customer profile for recording customer and shopping information associated with a particular customer is generated. At least one customer visit to a store is recorded in the customer profile based upon the presence of a customer device at the store. At least one customer purchase at the store, an affiliated store, or affiliated website is recorded and a loyalty reward is calculated based upon the at least one customer visit and the at least one customer purchase. The loyalty reward is then awarded to the customer.

A customer may, at a customer service desk in a store, on the store website, or through a mobile application, have a user profile created that includes customer information such as the customer's name, and account ID, password, and other information. This customer information may then be associated with shopping information in a database. The shopping information may include aggregate and discrete shopping data regarding customer visits to a brick-and-mortar location and/or online shopping. In particular, the date, time, duration, amount spent and/or products purchased may be recorded.

After installation of the mobile application on a smart device and the generation of a customer profile, a customer may visit a retail store. The mobile application may run in the background on the device and utilize the smart device's GPS, WiFi, data network, Bluetooth capabilities, or other hardware or software on the customer device to determine the presence of the device at the retail store and even the location of the device within the store. Data may be logged locally on the smart device and subsequently synched with a cloud based system via the internet or other network. The data may include shopping data such as the time the customer arrived, duration of shopping trip, and the amount spent. Alternatively, a network of location detection devices in the retail store coupled to a server via a network may detect and record the customer visit, customer path, and time spent in the retail store.

A customer with the application installed on their smart phone or other customer device, enters a retail store and the phone is detected. The presence of the phone is communicated to a data center for a record entry. The customer continues shopping and may scan items with the phone and make payment for them. The application sends this purchasing data to a data center such, as a server. Upon leaving the store, the phone's departure is logged and the system calculates customer reward points. At another location, using a web browser or the mobile application, the customer can view the points and rewards earned and use them on a subsequent shopping trip.

One failure of previous reward programs was that they could only record trips to a store during which the customer actually swiped or scanned their reward card. Many customer trips were not captured because the customer did not swipe or scan the card. Accordingly, the automatic logging of the time and duration of a shopping trip will capture at least some data about the customer visit even if the items purchased and amount spent are not logged. In fact, the frequency and duration of customer visits may be strongly correlated to customer spend and it is therefore beneficial to provide customer rewards based, at least in part, on these factors to encourage the behavior.

In addition to time and duration, the items purchased and amount spent may be recorded for customers electing to provide an identifier at checkout. Identifiers may include phone numbers, customer IDs, or scannable codes (such as barcodes, QR codes, and the like) displayed on the screen of the smart device at checkout. This data may also be collected by the use of a “scan-and-go” app on the customer device by which a customer scans items as they are put in their cart. Additionally, a “scan receipt” feature may be provided for the customer to scan their in-store receipt and have the items on that receipt associated with their profile.

A reward utility provides one or more algorithms for calculating a customer reward.

The reward may be based on aggregated or discrete data for a customer's shopping trips. This could include a rolling average number of visits per week or month, an average or total spend over time, and an average or total duration spent in the store over a period of time.

The reward may take several forms. For example, a customer may be awarded a percentage discount on the total spend on their next visit or a free or discounted item. In addition, items not commonly purchased by the customer may be recommended, with or without a discount, based on past shopping habits.

Since an application on the customer device, and/or the location detection devices, in the retail store, will know when the customer is in the retail store, the timing of providing rewards may be done to maximize their effect. For example, a customer may be provided a discount reward while in the store to encourage an increased total spend for that trip. In addition, should a customer not have logged a recent visit, a reward may be selected to encourage a return to the store.

Because the application can be on a mobile smart customer device and the data stored on a server of the retail store, the reward program may also be used in conjunction with an online store. Additional data including time spent shopping on the store website or through a shopping app, time spent, and number of site visits or application launches may also be used to calculate the rewards.

The application and/or a website may allow the customer to view their reward profile to see what rewards they may be eligible for or nearing eligibility for. In some embodiments, the customer may be provided with more than one reward to choose from. This allows for the system to collect additional information about the customer's preferences.

The reward algorithm may calculate reward points for the customer. These may be used to determine what reward has been earned or redeemed by the customer for a reward. The points may be perishable base on the date they were earned and the system may include a reminder feature to indicate to the customer when points may be expiring. This can be another way to encourage a customer visit or purchase that may not otherwise occur.

The system and methods may also facilitate multiple participation levels. These may include paid or free programs, categorizing customers into tiers based on reward points and providing escalating rewards for each tier, and varying algorithms among tiers. The multiple participation levels can create a game effect where customers will want to improve their tier level by increasing frequency and/or duration of shopping trips.

More refined data may also be collected including the parts of a store visited. For example, a customer that routinely visits a sporting goods area may be provided with related rewards such as a discount on goods in that department. This may be particularly useful for situations where a customer has not purchased goods in that department but may be considering a major purchase. In that case, the customer spend and items purchased would not indicate that the customer is contemplating such a purchase, but their repeated presence in the department may. Providing that customer with a discount targeted to that department may increase the likelihood of the major purchase being made.

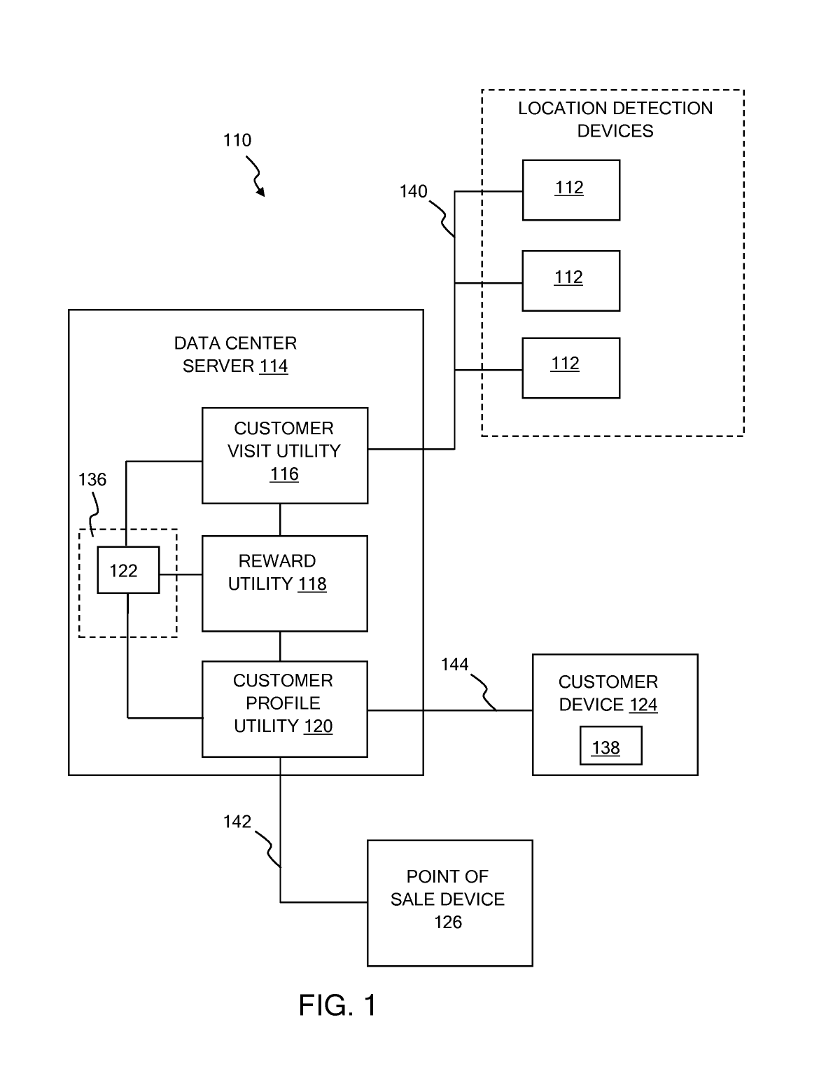

FIG. 1 shows a block diagram of an embodiment of a system 110 for implementing a visit-based loyalty reward program. System for implementing a visit-based loyalty reward program 110 includes a data center server 114 coupled to a network. In the embodiment shown in FIG. 1, data center server 114 is coupled to network 140 and network 142. In some embodiments, data center server is coupled to more than two networks. In some embodiments, data center server 114 is coupled to one network, such as when network 140 and network 142 are couple together, becoming the same network, for example. System 110 also includes a plurality of location detection devices 112, a customer device 124, and a point of sale device 126.

Data center server 114 resides in the retail store facility in this embodiment, and stores and processes the visit-based loyalty reward program data. In this embodiment data center server 114 is a server device, but this is not mean to be limiting. Data center server 114 can be replaced with any computing device that can store, process, and manipulate data and can be software, hardware, or any combination of software and hardware. Data center server 114 can be located at any local or remote facility or location, as long as it is coupled to a network such as network 140 and 142 in this embodiment.

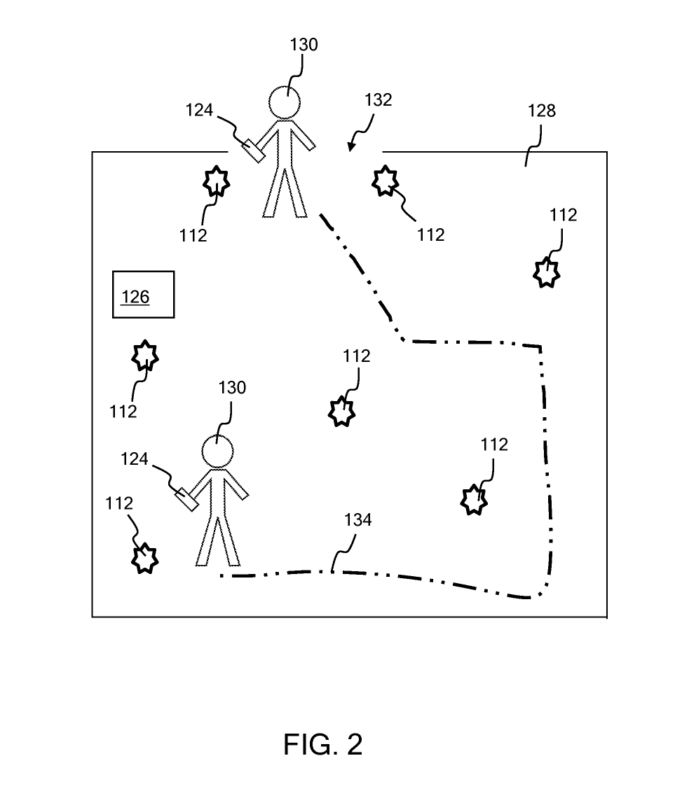

In the embodiment shown in FIG. 1, data center server 114 includes memory 136 which stores customer profiles of the retail store customers. FIG. 1 illustrates one customer profile 122 in date center server 114, but it is to be understood that data center server 114 stores a unique customer profile for each customer of the retail store. Data center server 114 is configured to store customer profile 122, as explained herein. Customer profile 122 is associated with a customer 130 as shown in FIG. 2, and includes customer information, including customer visit, customer purchases, and other information. FIG. 2 illustrates, in simplified drawing form, customer 130 visiting a retail store 128 equipped with the plurality of location detection devices 112 and point of sale device 126.

Data center server 114 is coupled via network 140 to the plurality of location detection devices 112. Location detection devices 112 are positioned within and around retail store 128 and are used to detect the presence, location, and a path 134 of customer 130 in retail store 128, see FIG. 2. Location detection devices 112 detect the presence of customer 130 by detecting the presence of customer device 124 carried by customer 130. Thus, location detection devices 112 detect the presence, location, and path 134 of customer device 124, where customer device 124 is associated with customer 130. Network 140 can be any type of communication network, wired or wireless, routed through the internet or not. Location detection devices 112 can be any type of device that can be used to detect the presence, location, or path of customer device 124. In some embodiments, application 138 on customer device 124 does the calculations of presence, location, and path, and sends this information to data center server 114 or one or more of plurality of location detection devices 112. In some embodiments, location detection devices 112 perform the detection, location and presence calculations and send the information to data center 114. In some embodiments, location devices 112 send data to data center server 114, customer device 124 sends data to data center server 114, and a customer visit utility 116 of data center server 114 performs the calculations to determine the presence, location, and path 134 of customer device 124. “Utility” as used in this document means a system, apparatus, or program that performs decisions, computations, or operations. A utility can be a software program, a hardware circuit, firmware, or any combination of these or other devices, circuits, or systems.

In some embodiments, one or more of location detection devices 112 can use triangulation to detect the location of customer device 124. In this embodiment, the location of customer device 124 can be determined by calculating the distance and angle between three or more reference nodes whose position is known. In some embodiments, visible light communication is used to detect the presence, location, or path 134 of customer device 124. Signals can be encoded onto light emitting device (LED) fixtures or bulbs in retail store 128. These LED emitters, or light beacons, can be used to transmit the encoded light signal to a camera on customer device 124. Application 138 on customer device 124 can decode the signal from the light beacons to determine the position of customer device 124 relative to the light beacon transmitters.

In some embodiments, one or more of location detection devices 112 can use Bluetooth™ communication to detect the presence, location, or path 134 of customer device 124. A Bluetooth™ transmitter can be used as a Bluetooth™ beacon to emit a signal that includes a unique identifier, a major code, a minor code, and the signal strength. An application on customer device 124 can use the received Bluetooth™ beacon to determine proximity to the beacon, or precise location when using multiple beacons.

In some embodiments, location detection devices 112 can be audible or ultrasonic beacons that transmit sound or ultrasound. Application 138 on customer device 124 can detect the sound or ultrasound through a microphone, and use the sound to perform presence, location or path 134 computations. In some embodiments, a compass within customer device 124 can use magnetic resonance to detect variations in the earth's magnetic field to determine the location of customer device 124 within the retail store's structural iron. In some embodiments, accelerometers in customer device 124 can be used to determine by dead reckoning the orientation, speed, and direction of travel of customer device 124. In some embodiments, a global navigation satellite system (GNSS) device in customer device 124 can be used to determine the location, attitude, and path 134 of customer device 124.

In some embodiments, video cameras on customer device 124, or in retail store 128, can be used to detect the presence, location, or path 134 of customer device 124 or customer 130 via image recognition or video recognition. In some embodiments, location detection devices 112 are location signposts or tags that use barcodes, images, or data transmission such as Bluetooth™ transmissions, ultra wideband transmissions, near-field communications transmission, or radio-frequency transmissions which application 138 can use to recognize its location, presence, or path within retail store 128.

Customer device 124 can be any type of computerized mobile computing or communication device carried by customer 130. Customer device 124 is communicatively coupled to customer profile utility 120 via communication network 144. In this embodiment, network 144 is wireless, but this is not meant to be limiting. In some embodiments, communication network 144 is wired. Communication network 144 can be any network or connection that supports communication between customer device 124 and data center server 114.

The presence, location, and path 134 of customer 130 within retail store 128 is computed by or delivered to customer visit utility 116 of datacenter server 114, which provides this information to reward utility 118. Customer visit utility 116 is communicatively coupled to plurality of location detection devices 112, customer profile 122, and reward utility 118. Customer visit utility 116 stores the frequency and duration of customer visits by customer 130 to retail store 128. In some embodiments, customer visit utility 116 computes the path 134 of customer 130 in retail store 128. In some embodiments, customer visit utility 116 records the path 134 of customer 130 in retail store 128 using data received from location detection devices 112 or customer device 124. In some embodiments, customer visit utility 116 receives the path 134 of customer 130 in retail store 128 from customer device 124. In some embodiments, customer visit utility 116 receives the path 134 of customer 130 in retail store 128 from location detection devices 112.

Data center server 114 is coupled via network 142 to point of sale device 126. In this embodiment point of sale device 126 is a computerized point of sale device configured to capture customer purchase information associated with customer 130. Point of sale device 126 delivers the customer purchase information to a customer profile utility 120. Customer profile utility 120 processes the customer purchase information and delivers it to customer profile 122 and a reward utility 118. Network 142 in this embodiment is a hardwired network, but this is not meant to be limiting. In some embodiments, network 142 is wireless.

Data center 114 includes reward utility 118. Reward utility 118 is communicatively coupled to customer profile 122, customer visit utility 116, and customer profile utility 120. Reward utility 118 computes rewards for customer 130 based on visits to retail store 128, duration of visits to retail store 128, path 134 through retail store 128, and/or purchases made at retail store 128, for example. In some embodiments, reward utility 118 uses other data to compute rewards. Reward utility 118 assigns a reward to customer profile 122 based on plurality of location detection devices 112 detecting the presence of customer device 124 in retail store 128. Reward utility 118, in some embodiments, assigns a reward to customer 130 based on the frequency and duration of visits to retail store 128. In some embodiments, reward utility 118 sends a coupon to customer 130 based on path 134 of customer 130 in retail store 128. In some embodiments, reward utility 118 sends a reward to customer device 124 in response to plurality of location detection devices 112 detecting the presence of customer device 124 in retail store 128. In some embodiments, reward utility 118 sends a coupon to customer device 124 in response to plurality of location detection devices 112 detecting the presence of customer device 124 in retail store 128.

Data center server 114 includes customer profile utility 120. Customer profile utility 120 is communicatively coupled to customer profile 122, reward utility 118, and point of sale device 126. Customer profile utility 120 is also communicatively coupled to customer device 124 when customer device 124 in in retail store 128, or otherwise in connection (via the internet, for example) with customer profile utility 120. Customer profile utility 120 stores the customer purchase information associated with customer 130. Customer profile utility 120 provides the customer purchase information to reward utility 118. In some embodiments, reward utility 118 uses the customer purchase information to choose a reward for customer 130.

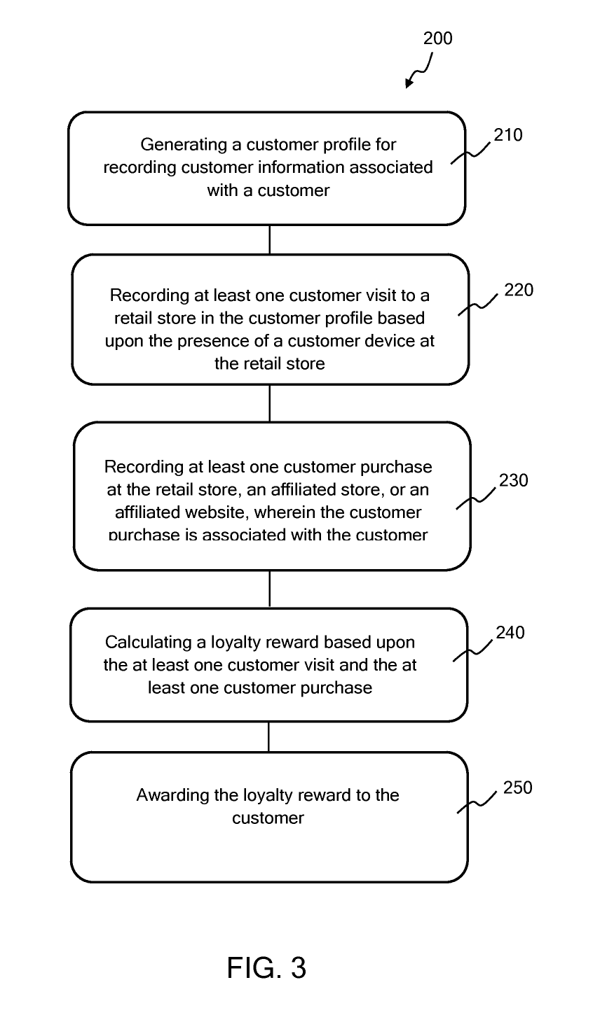

FIG. 3 illustrates method 200 for implementing a visit-based loyalty rewards program. Method 200 includes an act 210 of generating a customer profile for recording customer information associated with a customer. Method 200 also includes an act 220 of recording at least one customer visit to a retail store in the customer profile based upon the presence of a customer device at the retail store. Method 200 for implementing a visit-based loyalty rewards program also includes an act 230 of recording at least one customer purchase at the retail store, an affiliated store, or an affiliated website, where the customer purchase is associated with the customer. Method 200 includes an act 240 of calculating a loyalty reward based upon the at least one customer visit and the at least one customer purchase. And, method 200 includes an act 250 of awarding the loyalty reward to the customer.

In some embodiments, the presence of the customer device at the store is determined by one or more interactions between the customer device and another system by way of GPS, Bluetooth, or WiFi connectivity. In some embodiments, the step of recording the at least one customer visit includes calculating a duration of the visit by subtracting a start time of the visit form an end time of the visit. In some embodiments, act 240 of calculating is based, at least in part, on the duration of a customer visit. In some embodiments, the reward is at least one of a discount, redeemable points, cash, or a cash equivalent. In some embodiments, the reward is calculated based on the total customer purchase value over a period of time. In some embodiments, the reward is calculated based on the total profit realized by the store for customer purchases made during the period of time. In some embodiments, the reward includes redeemable reward points that expire based upon a date on which they were earned.

In some embodiments, method 200 includes the act of notifying the customer in advance of redeemable points expiring. In some embodiments, the act of notifying is carried out by sending a message to the customer device when it is in the store.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description herein is for the purpose of describing particular embodiments only and is not intended to be limiting of the invention. As used in the description of the embodiments and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

Thus, there has been shown and described several embodiments of a novel invention. As is evident from the foregoing description, certain aspects of the invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

1. A system for implementing a visit-based loyalty reward program, the system comprising:
a server having a memory and coupled to a network, the server configured to store a customer profile in the memory, wherein the customer profile is associated with a customer;
a plurality of location detection devices configured to detect the presence of a customer device in a retail store, wherein the customer device is associated with the customer;
a computerized point of sale system configured to capture customer purchase information; and
a reward utility resident on the server, wherein the reward utility assigns a reward to the customer profile in response to the plurality of location detection devices detecting the presence of the customer device in the retail store.

2. The system of claim 1, further comprising a customer visit utility coupled to the plurality of location detection devices, wherein the customer visit utility stores the frequency and duration of customer visits by the customer to the retail store.

3. The system of claim 3, wherein the reward utility assigns a reward to the customer based on frequency and duration of customer visits to the retail store.

4. The system of claim 2, wherein the customer visit utility records a path of the customer device in the retail store.

5. The system of claim 4, wherein the reward utility assigns a reward to the customer based on the path of the customer in the retail store.

6. The system of claim 4, wherein the reward utility sends a coupon to the customer device based on the path of the customer in the retail store.

7. The system of claim 1, further comprising a customer profile utility, wherein the customer profile utility stores the customer purchase information in the customer profile, and wherein the reward utility uses the customer purchase information to choose the reward.

8. The system of claim 1, wherein the reward is sent to the customer device in response to detecting the presence of the customer device in the retail store.

9. The system of claim 1, wherein a coupon is sent to the customer device in response to detecting the presence of the customer device in the retail store.

10. The system of claim 1, wherein at least one of the location detection devices uses a light beacon to detect the presence of the customer in the retail store.

11. The system of claim 1, wherein the plurality of location detection devices use Bluetooth™ communication to detect the presence of the customer in the retail store.

12. The system of claim 1, wherein at least one of the location detection devices uses magnetic resonance to detect the presence of the customer in the retail store.

13. The system of claim 1, wherein the plurality of location detection devices uses triangulation to detect the presence of the customer in the retail store.

14. The system of claim 1, wherein at least one of the location detection devices uses sound to detect the presence of the customer in the retail store.

15. The system of claim 1, wherein at least one of the location detection devices uses a video camera to detect the presence of the customer in the retail store.
